(19) United States
(12) Patent Application Publication
(10) Pub. No.: US 2012/0082808 A1
(43) Pub. Date: Apr. 5, 2012

(54) METHOD FOR INSTALLING HEAT SHIELDING ON A FIXED INTERNAL STRUCTURE OF A JET ENGINE NACELLE

(75) Inventors: Laurence Lemains, Saint Sauveur d'Emmalleville (FR); Pascal Mer, Le Havre (FR)

(73) Assignee: AIRCELLE, Gonfreville L'Orcher (FR)

(21) Appl. No.: 13/321,908

(22) PCT Filed: Jun. 9, 2010
(86) PCT No.: PCT/FR10/51148

§ 371 Date: Nov. 22, 2011

(30) Foreign Application Priority Data
Jun. 15, 2009 (FR) 0902902

(51) Int. Cl. B32B 37/12; B32B 1/08; B32B 37/02

(52) U.S. Cl. 428/34.1; 156/60; 156/307.3; 156/275.5

(57) ABSTRACT

The invention relates to a method for installing heat shielding (31), including a heat cushion (33) covered with a ply (35a) made from a structural material, on a fixed internal structure (29) of a jet engine nacelle, including the following consecutive steps: spreading an adhesive (43) that guarantees good mechanical strength at high temperatures on at least one of the elements selected from said ply (35a) and an internal skin (39) of the fixed internal structure; applying said ply (35a) to said internal skin (39); and, if necessary, setting said adhesive (43).

### TECHNICAL FIELD

The present invention relates to a method for installing a heat shielding on a fixed internal structure of a jet engine nacelle.

### BRIEF DESCRIPTION OF RELATED ART

An airplane is moved by one or more jet engines each housed in a nacelle.

A nacelle generally has a tubular structure comprising an air intake upstream of the jet engine, an intermediate assembly intended to surround a fan of the jet engine, a rear assembly that can incorporate thrust reversing means and intended to surround the combustion chamber and all or some of the compressor and turbine stages of the jet engine, and generally ends with a jet nozzle whereof the outlet is situated downstream of the jet engine.

Modern nacelles are intended to house a dual-flow jet engine that can create, on the one hand, a hot air flow (also called primary flow) coming from the combustion chamber of the jet engine, and circulating in a space delimited by a compartment having a substantially tubular shape called core compartment, and on the other hand, a cold air flow (secondary flow) coming from the fan and circulating outside the jet engine through an annular passage, also called stream, formed between an inner structure defining a fairing of the jet engine and an internal wall of the nacelle. The two air flows are ejected from the jet engine through the rear of the nacelle.

The core compartment comprises an outer enclosure called inner fixed structure (IFS) comprising at least one panel. Two types of IFS panel composition are distinguished with, on the one hand, metal IFSs comprising a metal honeycomb sandwich-type panel (NIDA) held between two metal layers such as aluminum skins, potentially acoustically pierced on the stream side, and on the other hand, composite IFSs built on the same principle as their metal equivalent, but for which the metal layers are replaced with two inner (core compartment side) and outer (stream side) skins made from composite materials (for example: carbon/epoxy or carbon/BMI).

Given that the inner fixed structure is subject to high thermal stresses, it is necessary to shield the panels that make up the IFS through heat shields, in order to locally keep the temperatures at acceptable levels and extend the lifetime of the material. The role of the heat shields is to protect the components of the nacelle from the engine environment, these components being able to be impacted by the convection of the air coming from the core compartment, the temperature of which can typically reach 400° C., and by the radiation from the engine casing, the temperature of which can typically reach 750° C. The assembly formed by the IFS covered by a heat shield also performs a firewall role.

To thermally shield the IFS, it is known to use heat shields placed on the core compartment side, and comprising an insulating cushion, generally made up of silica fibers, ceramic or a microporous material, held between two stainless steel strips. The heat shield is fixed to the IFS using fixing systems that cooperate periodically with it over the entire surface of the shield, like rivets. The heat shield is also retained by its edges on the IFS by retaining strips called retainers. The placement of heat shields on the IFS with this type of fixing is lengthy (several dozens of hours), given that a significant number of repetitive operations are necessary.

On the other hand, the known heat shields are not adapted for the heat shielding of the composite IFSs comprising carbon/epoxy skins, given that these heat shields of the prior art do not make it possible to locally guarantee that the temperature is kept at a value of less than or equal to 120° C. while staying within thickness and/or mass ranges that are acceptable for aeronautics. This insufficiency in terms of technical performance therefore makes it difficult to use such carbon/epoxy skins, less expensive than their equivalent made from carbon/BMI which can withstand temperatures in the vicinity of 150° C. This point is particularly important, given the rapid expansion that composite materials are currently experiencing in aeronautics.

### BRIEF SUMMARY

The present invention resolves all or some of the previously mentioned drawbacks.

The primary aim of the invention is achieved, according to a first aspect, with a method for installing heat shielding, including a heat cushion covered with a ply made from a structural material, on a fixed internal structure of a jet engine nacelle, including the following consecutive steps:
spreading an adhesive that guarantees good mechanical strength at high temperatures on at least one of the elements selected from said ply and an internal skin of the fixed internal structure;
applying said ply to said internal skin; and
if necessary, setting said adhesive.

Thanks to such a method, it is not necessary to use fixing means to keep the heat shielding in position on the IFS, despite the high temperatures that can cause the pieces to come apart following local expansions. Consequently, it suffices to coat the surfaces to be put in contact for adhesion and to adjust them relative to one another, the adhesive withstanding high temperatures and the flatness of the ply made up of the structural material enabling the safe holding of the heat shielding on the IFS. The setting of the adhesive can be spontaneous after at least several minutes. Such setting can also be triggered using any means, considered alone or in combination, such as radiation, microwaves, induction, or temperature increase.

Such a method makes it possible to avoid having to use a large number of fixing means distributed over a larger part of fastening points and it avoids having to place retainers, which are costly; it is therefore compatible with a fast and inexpensive installation of the heat shielding on the IFS.

It is, of course, possible to consider implementing such a method to ensure heat shielding on other elements of the structure of an apparatus in the aeronautics field, and in particular the structural frames (for example the air intake or thrust reverser frames) or the engine casings (for example the outer casing of the fan stream).

The term “structural material” within the meaning of the present invention designates a material having good structural strength in a temperature range situated around 150° C., which can retain the heat cushion, i.e. the layer of insulating material.

According to other optional features of the method according to the invention:
said ply is a glass ply: glass is particularly adapted to adhesion, it allows optimal adhesion of the heat shielding on the IFS;
said heat cushion is adhered on said glass ply;
said heat cushion is covered with a flame-arresting material sealed against fluids, such as a sheet of stainless steel: such a tight material allows drainage of the hydrocarbons coming from the engine block, which is preferable given the excess weight caused by any retention of effluents and the damage that may be caused on the structure by such hydrocarbons, especially when it comprises composite materials; likewise, this drainage is essential to limit the fire-related risks, given that aeronautics standards prohibit the retention of flammable products in the form of voluminous pockets or porous materials such as the heat cushion;
alternatively, said heat cushion can be formed in a hydrophobic material, which makes it possible to do away with the placement of a fluid-tight layer;
said heat cushion is a heat cushion of the Pyrogel 6671 type: such a cushion is particularly suitable to guarantee optical heat shielding and has heat performances completely adapted to this type of application, and in particular allows the use of carbon/epoxy IFS skins that are more sensitive to heat constraints than their equivalents made from carbon/BMI; “of the [Pyrogel 6671] type” refers to any heat cushion having properties equivalent to those of that material;
the adhesive is applied by blocks: such a distribution of the adhesive between the heat shielding and the IFS makes it possible to have a stagnant air knife at that level and improves the heat insulation; the term “block” in the context of the present invention designates a restricted area on the surface of which the adhesive must be applied. Such a distribution of the adhesive discretely allows air pockets to form between the two surfaces;
the setting of the adhesive is spontaneous after at least several minutes;
alternatively, the setting of the adhesive is triggered by a means chosen in the group comprising radiation, exposure to microwaves, induction, or a temperature increase.

According to a second aspect, the present invention relates to an inner fixed structure having, on its inner surface on the core compartment side, a cushion of the Pyrogel 6671 type according to the method as previously described.

### BRIEF DESCRIPTION OF THE DRAWINGS

Other features and advantages of the present invention will appear in light of the following description in reference to the appended figures, in which:

FIG. 1 is an overall view, in longitudinal cross-section, of a jet engine nacelle according to the state of the art;

FIG. 2 shows a detailed view, in longitudinal cross-section, of an installation of the state of the art, in which an insulating cushion is installed on an IFS of a nacelle by fastening means known for that application;

FIG. 3 shows a detailed view, in longitudinal cross-section, of an installation implemented with a method according to the present invention, in which a Pyrogel 6671 insulating cushion is adhered on the IFS of a jet engine nacelle;

FIG. 4 is a table showing a comparison between the heat properties of a Pyrogel 6671 type cushion and the heat shieldings traditionally used.

### DETAILED DESCRIPTION

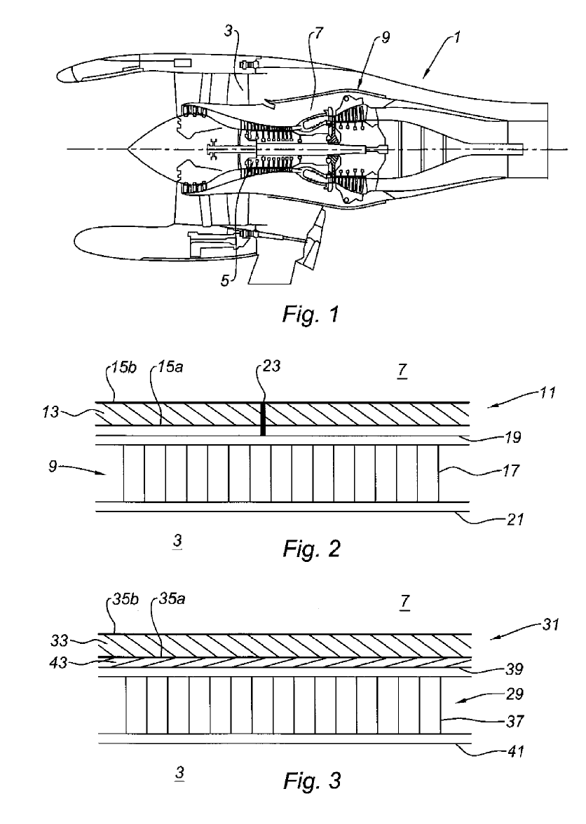

FIG. 1 shows a jet engine nacelle 1, seen in longitudinal cross-section, comprising a stream 3 in which the cold air circulates when the jet engine is operating, and a combustion chamber 5 partially surrounded by a core compartment 7 delimited on its outer portion on the stream side 3, by an inner fixed structure (IFS) 9.

FIG. 2 shows a heat shielding 11 fixed on the core compartment side 7 on the IFS 9. The heat shielding 11 comprises a heat cushion 13, like those used for heat shields of the structure of the Airbus A380, held between two stainless steel sheets 15a and 15b. The IFS 9 comprises a metal panel 17, of the honeycomb sandwich (NIDA) type, held between an inner skin 19 and an outer skin 21, which can be made from metal or a composite material.

The heat shielding 11 is fixed using a method known in the state of the art on the inner skin 19 of the IFS, using fixing means 23. Such fixing means 23 are distributed over a large number of fastening points on the entire surface of the inner skin 19 of the IFS on the core compartment 7 side. An air knife 24 separates the inner skin 19 from the heat shielding 11; it is generally one millimeter thick. Ventilation means, not shown, called “vent in” and “vent through” ensure, for the “vent in,” the ventilation of the insulating material, and for “vent through,” good distribution of the pressure between the air knife and the core compartment.

FIG. 3 shows an IFS 29 on which a heat shielding 31 is installed according to one embodiment of the method according to the present invention. The heat shielding 31 comprises a Pyrogel 6671 heat cushion 33 made up of plied silica aerogels in batting fibers held between, on the one hand, a glass ply 35a, and a stainless steel sheet 35b on the other. The Pyrogel 6671 cushions are manufactured by the company Aspen Aerogels (30 Forbes Road, Building B, Northborough, Mass. 01532—USA). The IFS 29, like the IFS 9, comprises a metal panel 37, of the honeycomb sandwich (NIDA) type, held between an inner skin 39 and an outer skin 41, which can be made from metal or a composite material.

The glass ply 35a of the cushion 33 is adhered with the adhesive 43 on the inner skin 39 of the IFS. To that end, it is first necessary to coat the glass ply 35a and/or the inner skin 39 of the IFS with adhesive 43, which can for example be of the APRONOR high T° C. 1000 type, or any other adhesive allowing temperature resistance and mechanical strength compatible with the stresses exerted at the

IFS. The APRONOR adhesive is manufactured by the company APRONOR (Zone industrielle Nord, 39 avenue de l'industrie, 76190 Ste Marie des Champs—France).

The operator then applies the ply 35a on the inner skin 39. A later step may be necessary to cause the adhesive to set, and one may, for example, use baking at a temperature of substantially 70° C., as is the case when one uses the APRONOR high T° C. 1000 adhesive. This is useful, given that, in that case, the operator can adjust the pieces relative to one another, in the case at hand the cushion relative to the IFS, without fearing premature setting of the adhesive. Ventilation means of the “vent through” type are not necessary in the installation of a heat shielding 31 on an IFS according to the embodiment shown in FIG. 3. However, it is possible to consider distributing the adhesive discretely, i.e. in blocks; in that case, the “vent throughs” are necessary.

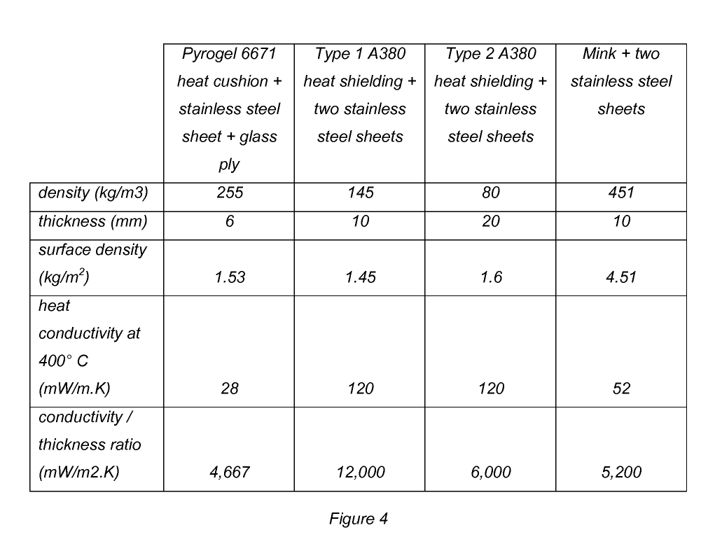

FIG. 4 illustrates the interest of using a heat shielding 31 comprising a cushion of the Pyrogel 6671 heat cushion type 33, in comparison with the cushions traditionally used such as those currently installed in the nacelles of Airbus A380 apparatuses. It emerges from table 1 that the Pyrogel 6671 cushions are more insulating than the cushions currently used. They are therefore better adapted to protecting IFSs with carbon/epoxy skins, which are among the most sensitive to heat stresses. Thus, to have the same heat performance as a Pyrogel 6671 heat cushion, it is necessary to use a much larger thickness in the case of a cushion traditionally used. Using a Pyrogel 6671 heat cushion is therefore particularly suitable for aeronautics, especially when the cushion equips a confined environment.

Of course, the present invention is in no way limited to the embodiments described and shown, provided merely as examples.

1. A method for installing heat shielding, including a heat cushion covered with a ply made from a structural material, on a fixed internal structure of a jet engine nacelle, the method comprising:
spreading an adhesive that guarantees good mechanical strength at high temperatures on at least one element selected from said ply and an internal skin of the fixed internal structure;
applying said ply to said internal skin; and
if necessary, setting said adhesive.

2. The method according to claim 1, wherein said ply is a glass ply.

3. The method according to claim 2, wherein said heat cushion is adhered on said glass ply.

4. The method according to one of claim 1, wherein said heat cushion is covered with a flame-arresting material sealed against fluids comprising a sheet of stainless steel.

5. The method according to claim 1, wherein said heat cushion is formed in a hydrophobic material.

6. The method according to claim 1, wherein said heat cushion is a heat cushion of the Pyrogel 6671 type.

7. The method according to claim 1, wherein the adhesive is applied by blocks.

8. The method according to claim 1, wherein the setting of the adhesive is spontaneous after at least several minutes.

9. The method according to claim 1, wherein the setting of the adhesive is triggered by a means comprising radiation, exposure to microwaves, induction, or a temperature increase.

10. The method according to claim 9, wherein the adhesive is an adhesive of the APRONOR high T° C. 1000 type.

11. An inner fixed structure having, on an inner surface on a core compartment side, a cushion of the Pyrogel 6671 type according to to the method of claim 1.
